(19) United States
(12) Patent Application Publication
(10) Pub. No.: US 2026/0254869 A1
(43) Pub. Date: Aug. 27, 2026

(54) ALLOCATING TRAFFIC FOR CONTENT DELIVERY NETWORKS (CDNS) BASED ON PERFORMANCE AND AVAILABILITY DATA

(71) Applicant: eBay Inc., San Jose, CA (US)

(72) Inventors: Junaid Akhtar, El Dorado Hills, CA (US); Hyeongjun Kim, Irvine, CA (US)

(73) Assignee: eBay Inc., San Jose, CA (US)

(21) Appl. No.: 19/062,384

(22) Filed: Feb. 25, 2025

(51) Int. Cl. H04L 67/101; H04L 67/1012

(52) U.S. Cl. CPC H04L 67/101; H04L 67/1012

(57) ABSTRACT

An automated system for allocating traffic for content delivery networks (CDNs) based on data is described. The system may receive performance and availability data associated with CDNs from one or more data sources. The data sources may include CDN providers, synthetic monitoring platforms, real user monitoring (RUM) platforms, and other data sources. The system may execute a model or a steering logic for allocating traffic to one or more CDNs based on the data. Using on the model, the system may determine or calculate metrics associated with at least one of global availability, regional availability, or regional performance of the CDNs, and other metrics based on which data sources are applicable. The system may allocate traffic to the one or more CDNs based on the metrics. Allocating the traffic may include costing-out (e.g., directing traffic away from) or costing-in (e.g., directing traffic to) CDNs.

### BACKGROUND

A content delivery network (CDN) may include a network of distributed servers located in various geographic regions to support the delivery of web content and services to end-users. When a user accesses a website, for example, a CDN may direct an associated request to a nearest or otherwise most optimal server. Some enterprises, such as online marketplaces, may utilize multiple CDNs to support large amounts of traffic that may be highly variable. However, delivering such traffic using a CDN may result in a single point of failure (SPOF). If an outage occurs at a given CDN, it may be difficult to quickly determine which CDN experienced the outage and how to cost-out the CDN experiencing the outage (e.g., direct the traffic to another CDN to avoid the outage). Manually costing-out a given CDN may be time and resource-intensive, particularly for large enterprises with numerous domains and large amounts of end-user traffic.

### SUMMARY

An automated process for allocating traffic for CDNs based on performance and availability data is described. Specifically, the described techniques support CDN automatic steering (auto-steering) based on global and regional availability and performance of the CDNs. In one or more implementations, a system may collect data associated with CDNs in a multi-CDN system from one or more data sources. The data may include information associated with availability and performance of CDNs at a global and regional scale, and the data sources may include CDN providers, synthetic monitoring platforms, and mobile native platforms that support real user monitoring (RUM), among other data sources.

Using the data, the system may execute a steering logic (e.g., a model) for allocating traffic to one or more CDNs. The steering logic may determine metrics associated with the availability of the CDNs and the performance of the CDNs based on the data. That is, the steering logic may calculate or otherwise determine the metrics based on information collected about the availability and performance of the CDNs. The steering logic may allocate the traffic to the one or more CDNs based on the metrics. For example, a global or regional availability of a CDN falling below a threshold availability may trigger the steering logic to cost-out a CDN and allocate traffic to other CDNs. In some examples, a domain name system (DNS) platform may be provided with the metrics and determination to cost-out a CDN from the steering logic, and the DNS platform may facilitate the actual direction of traffic to and from particular CDNs.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a steering logic for allocating traffic for CDNs based on performance and availability data in accordance with aspects of the present disclosure.

FIGS. 3 through 5 depict examples of flow diagrams for allocating traffic for CDNs based on performance and availability data in accordance with aspects of the present disclosure.

FIG. 6 depicts a procedure in an example implementation of allocating traffic for CDNs based on performance and availability data in accordance with the aspects of the present disclosure.

FIG. 7 illustrates an example of a system that includes an example computing device that is representative of one or more computing systems and/or devices that may implement the various techniques described herein.

### DETAILED DESCRIPTION

### Overview

An automated process for allocating traffic for CDNs based on performance and availability data is described. In accordance with the described techniques, one or more CDNs may support delivery of web content and services to end-users. For example, a CDN may direct a request to a nearest or otherwise most optimal server and handle traffic to the web content and services. As another example, the CDN auto-steering process provided herein can support multiple CDNs while maintaining the high availability services that are served by one or more particular CDNs during or before an interruption.

Delivering traffic for web services through a CDN may introduce the potential of an SPOF, even if the CDN provides a high-availability infrastructure. To support large and variable amounts of traffic, and to prevent an SPOF from interrupting web services, some enterprises may utilize multiple CDNs (i.e., a multi-CDN system) for manually steering traffic (e.g., with a static number of ratios). Some such enterprises may operate an online marketplace for buying and selling items and utilize a multi-CDN system for main static services, including a system image and programming files, and main dynamic services, including a mobile application (e.g., Mobile Native) and an API.

If an outage occurs for a single CDN in a multi-CDN system, a DNS platform may direct user traffic to mitigate the impact of the outage. That is, an engineer (e.g., a system administrator or other human actor) may use the DNS platform to direct user traffic away from the CDN that experienced the outage and toward other CDNs in the multi-CDN system to continue serving the amount of traffic for dynamic and static services. In some implementations, the DNS platform may be used to balance traffic manually based on a static number of ratios (e.g., an equal percentage of the traffic may be allocated to each CDN). However, when an outage occurs, it may take time to identify which CDN actually experienced the CDN in a multi-CDN system. Moreover, once the problematic CDN is identified, directing user traffic away from that CDN requires manual action and may take significant amounts of time, which may depend on the skill and knowledge of the engineer involved. For example, the engineer may use a DNS platform to manually cost-in or cost-out specific servers of a problematic CDN or the entire CDN, which may take 15 minutes or longer in some cases. Some web content or services may be lost during the DNS operations, and a CDN outage may result in a gap of capacity and functions that CDN supported.

Moreover, CDN outages may occur based on infrastructure issues (e.g., hardware failures, network issues, configuration errors) or for other reasons. For example, Internet service provider (ISP) network issues regarding a connection between a CDN and an origin network, client ISP network issues, human fault when configuring CDNs, and other issues may result in CDN outages.

In some cases, a CDN implemented with a CNAME delegation may be a single CDN. In such cases, if the CDN has an outage or increasing amounts of errors, a system may remove traffic from the CDN without first performing health checks on the CDN. However, removing traffic from a single CDN in this way may cause origin resource issues when an origin server takes a request from an end user without caching the behavior at the CDN. Removing the CDN from a service domain may require a manual change of the DNS from the CDN's CNAME domain to the origin's CNAME. Moreover, in a multi-CDN system, traffic may be balanced based on a DNS round-robin technique, which also may require manual action to remove a problematic CDN. Such manual changes may be time and resource intensive.

To mitigate the impact of a CDN outage in a multi-CDN system and eliminate the manual action currently required to direct traffic to different CDNs, an automated process for allocating traffic for CDNs based on performance and availability data is described. In one or more implementations, the described techniques involve CDN auto-steering based on global and regional availability and performance of the CDNs. In one or more implementations, a system may collect data associated with CDNs in a multi-CDN system from one or more data sources. The data may include information associated with availability and performance of CDNs at a global and regional scale, as well as any other information regarding the health of the CDNs. The data sources may include CDN providers, synthetic monitoring platforms, and mobile native platforms that support RUM, among other data sources.

Using the data, the system may execute a steering logic (e.g., a model) for allocating traffic to one or more CDNs. The steering logic may determine metrics associated with the availability of the CDNs and the performance of the CDNs based on the data. That is, the steering logic may calculate or otherwise determine the metrics based on information collected about the availability and performance of the CDNs. The steering logic may allocate the traffic to the one or more CDNs based on the metrics. For example, a global or regional availability of a CDN falling below a threshold availability may trigger the steering logic to cost-out a CDN and allocate traffic to other CDNs. In some examples, a DNS platform may be provided with the metrics and determination to cost-out a CDN from the steering logic, and the DNS platform may facilitate the actual direction of traffic to and from particular CDNs.

The described techniques may enable CDN auto-steering to automatically steer traffic away from a problematic CDN that experienced an outage to reduce the impact of the outage on web services and maintain high-availability web services that are served by CDNs. By automating CDN steering, the described techniques may improve the speed and efficiency of costing-in and costing-out CDNs. Analyzing data on global and regional bases is more fine-tuned than broader data, which may improve accuracy of the auto-steering. In addition, the described techniques enable the DNS and GMT platform to route traffic to different CDNs when an outage has occurred, which occurs transparently to the user without disrupting user experience. The described techniques also support updates to the steering logic after each costing-in or costing-out of a CDN. Such continuous improvement of the steering logic may improve the performance of the CDN auto-steering over time.

In some aspects, the techniques described herein relate to a computer-implemented method including: receiving, from one or more data sources, data associated with a one or more CDNs; executing a model for allocating traffic to the one or more CDNs based on the data; determining, by the model, metrics associated with an availability of the one or more CDNs or a performance of the one or more CDNs; and automatically allocating the traffic to the one or more CDNs based on the metrics.

In some aspects, the techniques described herein relate to a computer-implemented method, wherein determining the metrics associated with the availability further includes calculating, by the model, a global availability of each CDN of the one or more CDNs based on the data, wherein the data includes a number of requests associated with each CDN and a number of errors associated with each CDN; and allocating the traffic to the one or more CDNs based on the global availability of the one or more CDNs satisfying a threshold.

In some aspects, the techniques described herein relate to a computer-implemented method, wherein determining the metrics associated with the availability further includes calculating, by the model, a regional availability of each CDN of the one or more CDNs based on the data, wherein the data includes a number of requests associated with each CDN and a number of errors associated with each CDN; and allocating the traffic to the one or more CDNs based on the regional availability of the one or more CDNs satisfying a threshold.

In some aspects, the techniques described herein relate to a computer-implemented method, wherein determining the metrics associated with the performance further includes calculating, by the model, a regional performance of each CDN of the one or more CDNs based on the data; and allocating the traffic to the one or more CDNs based on the regional performance of the one or more CDNs.

In some aspects, the techniques described herein relate to a computer-implemented method, wherein the data is received from the one or more data sources based on at least one of synthetic monitoring or RUM.

In some aspects, the techniques described herein relate to a computer-implemented method, wherein determining the metrics associated with the availability and the performance further includes calculating, but the model, a weight corresponding to each CDN of the one or more CDNs, wherein the weight indicates a percentage of the traffic to be allocated to each CDN; and allocating the traffic to the one or more CDNs based on the weight of the one or more CDNs.

In some aspects, the techniques described herein relate to a computer-implemented method, further including detecting one or more errors at an origin server, the one or more errors associated with an availability of the origin server; and executing the model for allocating the traffic without including the one or more errors in the data.

In some aspects, the techniques described herein relate to a computer-implemented method further including determining, based on the metrics, that a first CDN of the one or more CDNs experienced an outage, wherein the traffic is allocated to the one or more CDNs except for the first CDN based on the outage.

In some aspects, the techniques described herein relate to a computer-implemented method, wherein automatically allocating the traffic further includes switching the traffic from a first CDN to a second CDN of the one or more CDNs based on a performance or an availability of the second CDN being more than a performance or an availability of the first CDN.

In some aspects, the techniques described herein relate to a computer-implemented method, further including calculating, by the model, an average availability of each CDN of the one or more CDNs based on an availability of each CDN and a quantity of time periods during which the availability was measured; and allocating the traffic to the one or more CDNs based on the average availability of the one or more CDNs.

In some aspects, the techniques described herein relate to a computer-implemented method, wherein the one or more data sources include at least one of a CDN provider, an Internet performance monitoring platform, or RUM.

In some aspects, the techniques described herein relate to a computer-implemented method, further including sending an indication of the allocation of the traffic to a DNS platform via an application programming interface (API) call.

In some aspects, the techniques described herein relate to a computer-implemented method, further including generating a visual representation of the allocation of the traffic to the one or more CDNs; and sending, for display via a user interface, the visual representation.

In some aspects, the techniques described herein relate to a system including: one or more processors; and memory storing instructions that, when executed by the one or more processors, cause the system to: receive, from one or more data sources, data associated with a one or more CDNs; execute a model for allocating traffic to the one or more CDNs based on the data; determine, by the model, metrics associated with an availability of the one or more CDNs or a performance of the one or more CDNs; and automatically allocate the traffic to the one or more CDNs based on the metrics.

In some aspects, the techniques described herein relate to a system, wherein the instructions to determine the metrics associated with the availability further cause the system to calculate, by the model, a global availability of each CDN of the one or more CDNs based on the data, wherein the data includes a number of requests associated with each CDN and a number of errors associated with each CDN; and allocate the traffic to the one or more CDNs based on the global availability of the one or more CDNs satisfying a threshold.

In some aspects, the techniques described herein relate to a system, wherein the instructions to determine the metrics associated with the availability further cause the system to calculate, by the model, a regional availability of each CDN of the one or more CDNs based on the data, wherein the data includes a number of requests associated with each CDN and a number of errors associated with each CDN; and allocate the traffic to the one or more CDNs based on the regional availability of the one or more CDNs satisfying a threshold.

In some aspects, the techniques described herein relate to a system, wherein the instructions to determine the metrics associated with the performance further cause the system to calculate, by the model, a regional performance of each CDN of the one or more CDNs based on the data; and allocate the traffic to the one or more CDNs based on the regional performance of the one or more CDNs.

In some aspects, the techniques described herein relate to a system, wherein the data is received from the one or more data sources based on at least one of synthetic monitoring or RUM.

In some aspects, the techniques described herein relate to a system, wherein the instructions to determine the metrics associated with the availability and the performance further cause the system to calculate, by the model, a weight corresponding to each CDN of the one or more CDNs, wherein the weight indicates a percentage of the traffic to be allocated to each CDN; and allocate the traffic to the one or more CDNs based on the weight of the one or more CDNs.

In some aspects, the techniques described herein relate to a system, wherein the instructions further cause the system to detect one or more errors at an origin server, the one or more errors associated with an availability of the origin server; and execute the model for allocating the traffic without including the one or more errors in the data.

In some aspects, the techniques described herein relate to a system, wherein the instructions further cause the system to determine, based on the metrics, that a first CDN of the one or more CDNs experienced an outage, wherein the traffic is allocated to the one or more CDNs except for the first CDN based on the outage.

In some aspects, the techniques described herein relate to a system, wherein the instructions to automatically allocate the traffic further cause the system to switch the traffic from a first CDN to a second CDN of the one or more CDNs based on a performance or an availability of the second CDN being more than a performance or an availability of the first CDN.

In some aspects, the techniques described herein relate to a system, wherein the instructions further cause the system to calculate, by the model, an average availability of each CDN of the one or more CDNs based on an availability of each CDN and a quantity of time periods during which the availability was measured; and allocate the traffic to the one or more CDNs based on the average availability of the one or more CDNs.

In some aspects, the techniques described herein relate to a system, wherein the one or more data sources include at least one of a CDN provider, an Internet performance monitoring platform, or RUM.

In some aspects, the techniques described herein relate to a system, wherein the instructions further cause the system to send an indication of the allocation of the traffic to a DNS platform via an API call.

In some aspects, the techniques described herein relate to a system, wherein the instructions further cause the system to generate a visual representation of the allocation of the traffic to the one or more CDNs; and send, for display via a user interface, the visual representation.

In some aspects, the techniques described herein relate to a system, wherein the instructions further cause the system to determine, by the model, the metrics associated with the performance of the one or more CDNs.

In some aspects, the techniques described herein relate to a system, wherein the instructions further cause the system to determine, by the model, the metrics associated with the availability of the one or more CDNs.

In some aspects, the techniques described herein relate to a non-transitory computer-readable media storing instructions that, when executed by one or more processors, cause the one or more processors to perform operations including: receiving, from one or more data sources, data associated with a one or more CDNs; executing a model for allocating traffic to the one or more CDNs based on the data; determining, by the model, metrics associated with an availability of the one or more CDNs or a performance of the one or more CDNs; and automatically allocating the traffic to the one or more CDNs based on the metrics.

In some aspects, the techniques described herein relate to a non-transitory computer-readable media, wherein the instructions further cause the one or more processors to determine, by the model, the metrics associated with the performance of the one or more CDNs.

In some aspects, the techniques described herein relate to a non-transitory computer-readable media, wherein the instructions further cause the one or more processors to determine, by the model, the metrics associated with the availability of the one or more CDNs.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

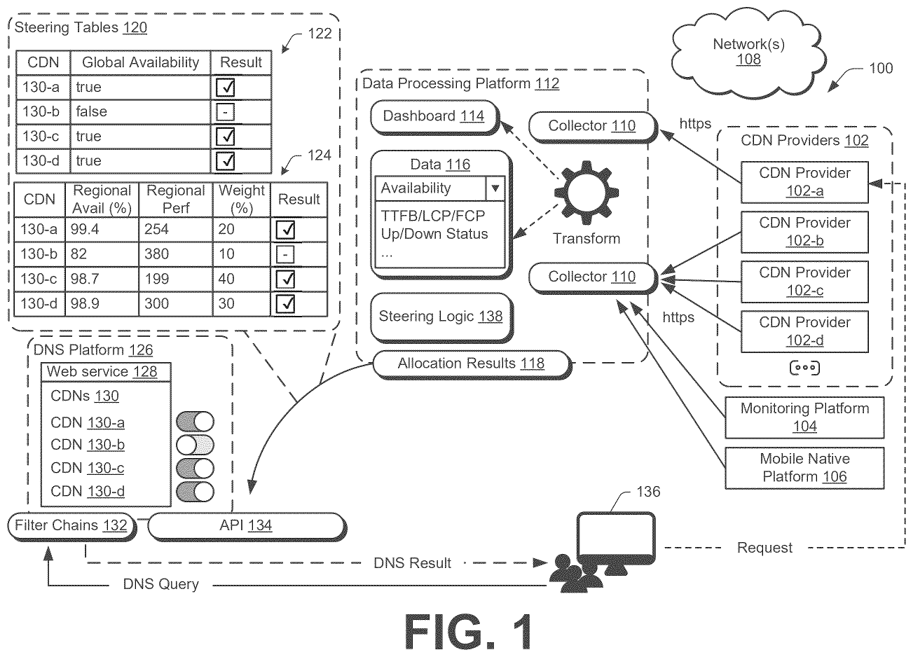

FIG. 1 is an illustration of an environment 100 in an example implementation that is operable to employ techniques described herein. The environment 100 includes CDN providers 102, a monitoring platform 104, a data processing platform 112, a DNS platform 126, and an online marketplace 136. In one or more implementations, the CDN providers 102, the monitoring platform 104, the data processing platform 112, the DNS platform 126, and the online marketplace 136 are communicatively coupled, one to another, via network(s) 108. One example of the network(s) 108 is the Internet, although one or more of the CDN providers 102, the monitoring platform 104, the data processing platform 112, the DNS platform 126, and the online marketplace 136 may be communicatively coupled using one or more different connections or different networks in various implementations (e.g., a cloud).

Although the monitoring platform 104, the data processing platform 112, the DNS platform 126, and the online marketplace 136 are depicted in the environment 100 as being separate from each other, in one or more implementations, an entirety or various portions of the monitoring platform 104, the data processing platform 112, the DNS platform 126, and the online marketplace 136 are implemented at or by a same computing device and/or service provider system. In at least one implementation, for example, at least a portion of the monitoring platform 104, the data processing platform 112, the DNS platform 126, and the online marketplace 136 are implemented by the computing device and/or using various resources of the computing device, such as hardware resources, an operating system, firmware, and so forth. Additionally, or alternatively, at least a portion of the monitoring platform 104, the data processing platform 112, the DNS platform 126, and the online marketplace 136 are implemented by resources (e.g., server-based storage, processing, and so on) of a service provider system. Alternatively, or additionally, at least a portion of the monitoring platform 104, the data processing platform 112, the DNS platform 126, and the online marketplace 136 are implemented using a third-party service, such as a web services platform that provides one or more hardware and/or other computing resources to support provision of services by web service providers.

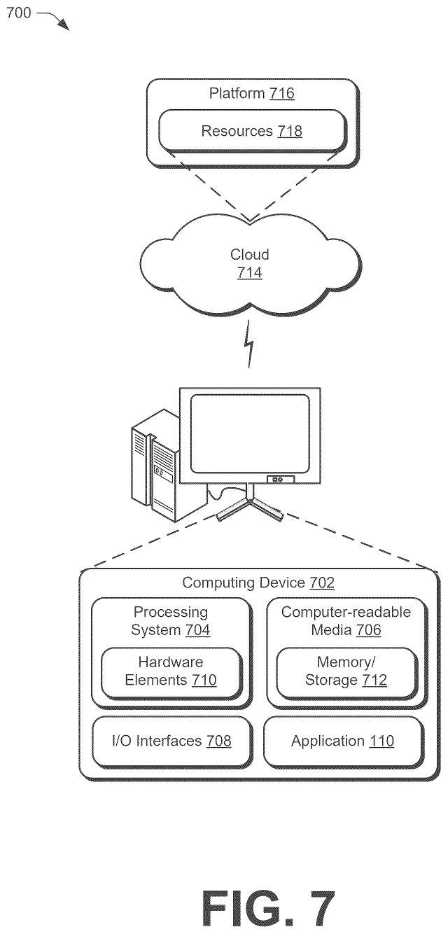

Computing devices that implement the environment 100 are configurable in a variety of ways. A computing device, for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 7.

In at least one implementation, the environment 100 supports CDNs 130 (e.g., CDN 130-a, CDN 130-b, CDN 130-c, CDN 130-d) operated by the CDN providers 102, which may include at least one of a CDN provider 102-a, a CDN provider 102-b, a CDN provider 102-c, or a CDN provider 102-d. For example, the CDN provider 102-a may operate a CDN 130-a, the CDN provider 102-b may operate a CDN 130-b, the CDN provider 102-c may operate a CDN 130-c, and the CDN provider 102-d may operate a CDN 130-d, and so on. Users of the online marketplace 136 may sent requests to a CDN to facilitate some experience or activity associated with a web service of the online marketplace 136. Some CDNs (e.g., one or more of CDN 130-a, CDN 130-b, CDN 130-c, CDN 130-d) may support static services of the online marketplace 136, while other CDNs 130 may support dynamic services of the online marketplace 136. Some CDNs 130 may support both static and dynamic services of the online marketplace 136. Each CDN 130 may host servers in hundreds or thousands of different geographical location. Some organizations (e.g., businesses or other enterprises) of a particular size may use a single CDN 130 that may perform at a high-level for that organization's web content and services. However, larger organizations (particularly those expecting large amounts of web traffic) may utilize a multi-CDN system, including at least two of the CDNs 130. In some examples, each CDN provider 102 may support one or more CDNs 130, so a multi-CDN system may be operated by the same CDN provider 102 or multiple CDN providers 102. The environment 100 is described in the context of a multi-CDN system.

To perform CDN auto-steering based on global and regional availability and performance of the CDNs 130, data associated with each CDN 130 may be provided to a collector 110 from one or more data sources. The data may be described herein as health checks of the CDNs 130. The data sources may include at least one of the CDN providers 102, the monitoring platform 104, a mobile native platform 106, or any other platform that may collect and share data about the performance of the CDNs 130. The monitoring platform 104 and the mobile native platform 106 may be external to the CDN providers 102.

In some implementations, the CDN providers 102 may generate and provide logs of raw availability and data when users connect with a corresponding CDN 130. Such raw data logs may include 1% or more sampled real-time logs corresponding to each CDN 130, and may have a data processing delay of under three minutes. The data logs also may account for any 50× errors by excluding 50× errors associated with origin response, where such errors may be associated with an availability of the origin server. For example, the data logs may include metrics such as an availability, which may be calculated as availability=((Total Request−Error Request)/Total Request)*100 % Total=Success+Error Request, where Total Request may represent a total number of requests received by a CDN 130 from users, Error Request may represent all 50× errors generated by an edge server of the CDN 130, excluding 50× errors from origin response, and Success may represent successful requests to the CDN 130. In this way, a percent origin error response is excluded from the Error Request metric so as to suppress CDN auto-steering actions when an origin server is experiencing errors.

The monitoring platform 104 (e.g., an Internet performance monitoring (IPM) platform) may use synthetic monitoring (e.g., simulating real user interactions with a web service to monitor performance) and RUM to obtain the availability and data corresponding to the CDNs 130. That is, the monitoring platform 104 may be a third-party monitoring tool that obtains availability and performance metrics from a synthetic web object or a full page test and RUM. The data collected by the monitoring platform 104 may include 100% sampled test results and may be associated with a data processing delay of under five minutes. The data may also account for all error codes that failed during a test on a web object.

In some examples, a test of the monitoring platform 104 may include web object URL monitoring from major global locations within a five-minute interval (e.g., % major locations may be related to a traffic ratio per country over 5%). In an example, users of the online marketplace 136 may be located in different geographical locations across the world. As modules, domains, checkout and payment platforms, and other web services the users may encounter on the online marketplace 136 may differ depending on the user's geographical location, the monitoring platform 104 may run tests of various experiences for different geographical locations. The monitoring platform 104 may monitor the availability and performance of the CDNs 130 for these various experiences through synthetic monitors and collect corresponding availability and data.

The data collected by the monitoring platform 104 may include a global availability for a CDN 130 and a global availability of the origin server, which both may be calculated as availability=((Total Request−Error Request)/Total Request)*100 % Total=Success+Error Request. Additionally, or alternatively, the data may include a TTFB+secure sockets layer (SSL) handshake time (TTFB(S)) metric. A TTFB(S) value may be calculated as DNS+Connect+Send+Wait+SSL %. DNS may be removed from TTFB(S) and SSL may be added for internal TTFB, where SSL may be a key object. The DNS is removed from the TTFB(S) calculation because DNS measurements may fail to represent end users accurately. Moreover, the TTFB(S) may account for the need to eliminate failure cases, such as a DNS timeout or a connect timeout when not all relevant objects for calculating the TTFB are available to prevent misreading of the TTFB during performance-based auto-steering.

Additionally, or alternatively, the monitoring platform 104 may collect data from RUM, which may include a random 1% or more sampled in real-time from test results and have a data processing delay under seven minutes. Such data may account for all 50× errors, and may include metrics such as global availability (e.g., availability=((Total Request-Error Request)/Total Request)*100% Total request count=Success+Error Request) and TTFB. The 50× errors may be associated with an availability of the origin server.

The mobile native platform 106 may use an internal application to collect data from user interactions with mobile native applications associated with the online marketplace 136. For example, the mobile native platform 106 may utilize a tool that measures site performance and obtains availability and data from mobile native RUM data. RUM data (collected by the monitoring platform 104 or the mobile native platform 106) may correspond to a user's experience on the online marketplace 136, such as whether the user is experiencing downtime, slowness or latency, and the like. Mobile native RUM may include a random 1% or more sampled in real-time from test results and may have a data processing delay of under three minutes. The mobile native RUM may also account for all 50× errors, and may include metrics such as global availability (e.g., availability=((Total Request-Error Request)/Total Request)*100% Total request count=Success+Error Request) and TTFB. Such errors may be associated with an availability of the origin server.

The various data sources may send the data to a collector 110 (e.g., of a security information and event management (SIEM) platform) via a connection such as hypertext transfer protocol secure (https). For example, the CDN provider 102-a may send the data to a collector 110, where the CDN provider 102-a may host the collector 110. Additionally, or alternatively, the CDN provider 102-b, the CDN provider 102-c, the CDN provider 102-d, the monitoring platform 104, and the mobile native platform 106 may transmit the data to a different collector 110, which may be an https-hosted collector. The collectors 110 may be ingress points by which the data processing platform 112 may receive data from the data sources.

The collectors 110 may provide the data to the data processing platform 112. The data processing platform 112 may be a log (e.g., data) processing tool that executes a steering logic 138 (e.g., a model) with queries. The data processing platform 112 may make an API call to the DNS platform 126 to control traffic balancing between different CDNs 130. The data processing platform 112 may use a transform to integrate the data collected from different data sources. Data 116 may be extracted, and the steering logic 138 may determine particular target objects from the data 116. For example, the steering logic 138 may analyze a time-to-first-byte (TTFB) metric, which may indicate how fast a CDN 130 is sending a response after receiving a request from a client, a first contentful paint (FCP), largest contentful paint (LCP), an up/down status of a CDN 130, where up-time may represent times during which the CDN 130 is available and down-time may represent times during which the CDN 130 is unavailable, and any other metrics that may be captured and exported via numerous sources. In some examples, the logic of the data processing platform 112 may parse the data from the data sources and materialize the data into one-minute-portion averages or sums (e.g., using a scheduled view feature).

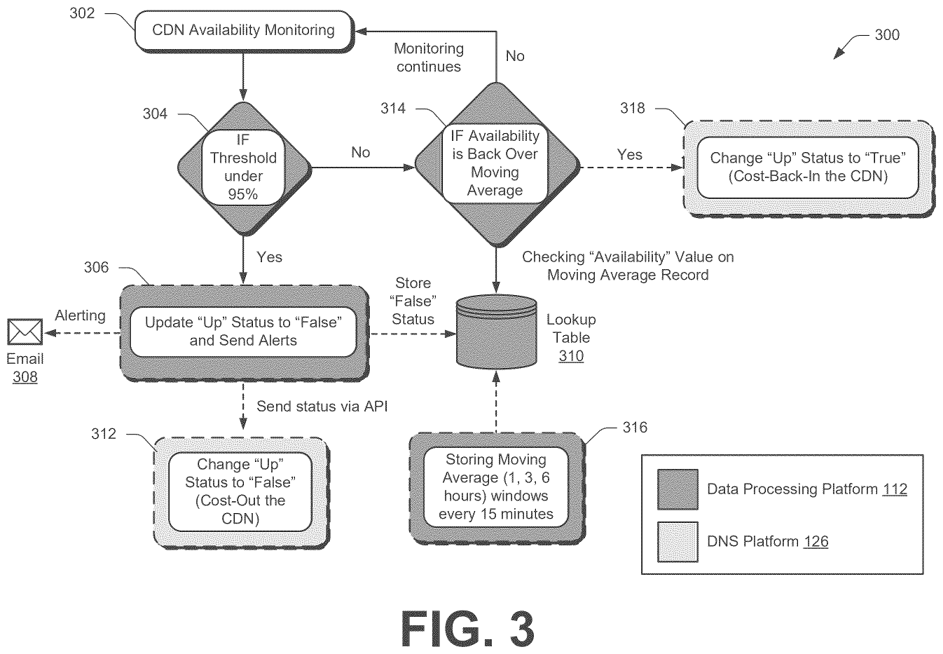

From the data 116, the data processing platform 112 may determine metrics such as global availability, regional availability, and regional performance for each applicable CDN 130 and organize the metrics into steering tables 120. For example, the steering tables 120 may include a global availability table 122, which may indicate a global availability of the CDNs 130 and a regional availability and performance table 124, which may indicate a regional availability (avail) and performance (perf) of the CDNs 130. Global availability corresponds to the availability of a CDN 130 to process requests globally, and regional availability corresponds to the availability of a CDN 130 to process requests regionally (e.g., across a city or state). In addition, regional performance corresponds to how well a CDN 130 performs in processing requests for a given region. In this way, the data processing platform 112 may run search queries in real-time for auto-steering using a monitoring feature (for global availability) and through a scheduled search feature (for regional availability and performance). Additional details regarding auto-steering based on global availability and regional availability and performance are described herein with reference to FIGS. 3-5.

In some examples, the steering logic 138 may utilize different performance metrics based on which data sources are available to provide availability and data to the steering logic 138. For example, the steering logic 138 may support larger data sources that may include more user samples per country or region, more autonomous system number (ASN) levels, and the like. Such data, for example, may enable the steering logic 138 to have more refined control of the auto-steering globally and regionally.

The steering tables may rank each CDN 130 and/or each CDN provider 102 based on their global availability or regional availability and performance. For example, the global availability table 122 may indicate that the CDN 130-a, the CDN 130-c, and the CDN 130-d have global availability (“true”) and that the CDN 130-b lacks global availability (“false”). Additionally, or alternatively, the regional availability and performance table 124 may indicate that the CDN 130-a has a regional availability of 99.4%, a regional performance of 254, and a weight of 20%, the CDN 130-b has a regional availability of 82%, a regional performance of 380, and a weight of 10%, the CDN 130-c has a regional availability of 98.7%, a regional performance of 199, and a weight of 40%, and the CDN 130-d has a regional availability of 98.9%, a regional performance of 300, and a weight of 30%. The weight in the regional availability and performance table 124 represents the balance of the CDNs 130, specifically how the CDNs 130 will balance traffic loads (e.g., the CDN 130-a may handle 20% of the traffic based on the regional availability and performance of the CDN 130-a).

In some implementations, the result for each CDN 130 may be based on a pre-determined threshold criteria. For example, if a regional availability or a regional performance for a CDN 130 is below a corresponding threshold, then that CDN 130 may be costed-out (corresponding to a “−” result). Alternatively, if a CDN 130 has a global or regional availability above a threshold, then the CDN 130 may be costed-in or may receive a greater allocation of traffic (corresponding to a “check” result).

When determining whether to cost-out or limit a CDN, the steering logic 138 may refrain from including errors and failures at the origin server in the data, because such origin errors and failures may decrease the availability of a CDN (even though the error may be at the origin server, not the CDN). The data processing platform 112 may support two logics (e.g., models) for suppressing origin error or failure conditions. In some examples, the data processing platform 112 may monitor for origin errors and failures using synthetic monitoring and detect the origin errors and failures based on the monitoring. The data processing platform 112 may perform such monitoring for particular types of CDN health checks (e.g., Layer 3 or Layer 7 health checks) and in some cases, for specific URLs.

In some other examples, the data processing platform 112 may detect 50× errors from origin server responses. A 50× error may specifically indicate an error or failure at the origin server. The origin server may also respond with backend application errors or failures. Such 50× errors may be caused by an application of the origin server (corresponding to the online marketplace 136), not by a CDN. The steering logic 138 may suppress the origin server's 50× errors to prevent such errors from causing a faulty costing-out condition. In some examples, the techniques described herein may be used for load balancing within the origin infrastructure of the online marketplace 136. For example, based on the availability of the origin server and any errors associated with that availability, the steering logic 138 may adjust data processing at the origin server accordingly.

In some implementations, the data processing platform 112 may present a visual depiction of the CDN auto-steering using charts and tables in a dashboard 114. Users may track and investigate steering conditions through the dashboard 114. In some examples, the data processing platform 112 may send auto-steering events (e.g., indications of changes in traffic allocations) to messaging applications, for example, using an incident management system. For example, system administrators may receive a notification that a CDN 130 or a CDN provider 102 was costed-out because of a decrease in performance.

Given the information in the steering tables 120, the data processing platform 112 may collect allocation results 118, which may represent the allocation of traffic to each of the CDNs 130 based on their respective global and/or regional availability and/or performance, and transmit the allocation results 118 to the DNS platform 126. For example, the data processing platform 112 may send a status (e.g., whether a CDN 130 is to handle traffic) and a numeric number (e.g., a weight or other indication of how much traffic is being allocated to a CDN 130) via a beacon or an API 134 connector setting on the data processing platform 112.

The DNS platform 126 may GTM through filters such as “up,” “weight,” “geo,” and other filters. That is, when the DNS platform 126 receives the allocation results 118, the DNS platform 126 may automatically cost-out or cost-in a CDN 130 or a corresponding CDN provider 102 based on the steering tables 120, which may improve efficiency of the system (e.g., instead of relying on manual adjustment of the CDNs 130). Costing-out a CDN 130 may include completely removing the CDN 130 and/or a corresponding CDN provider 102 or limiting the amount of traffic directed to the CDN 130 and/or the corresponding CDN provider 102. Costing-in a CDN 130 may include adding a previously costed-out CDN 130 and/or CDN provider 102 back into a rotation of usable CDNs 130. In some examples, the CDNs 130 may be balanced based on two filters, “UP” (e.g., up-status, corresponding to times when the CDN 130 is available), as indicated by “true” or “false” in the steering tables 120, and “weight,” which may be balanced evenly between four CDNs 130 (e.g., 25%) or three CDNs 130 (e.g., 33%). By using auto-steering, the “UP” and “weight” metrics may be automatically updated such that the logic of the data processing platform 112 may continuously control traffic.

The DNS platform 126 may facilitate the costing-out and costing-in based on users'interactions with the online marketplace 136. For example, when a user accesses a web service 128, the DNS platform 126 may receive a DNS query corresponding to the web service 128 via filter chains 132. In some implementations, the steering logic 138 may use the filter chains 132 to determine whether to cost-out a CDN or limit traffic to the CDN 130 based on availability and performance. For example, the filter chains 132 may be used to determine whether to cost-out a CDN 130 if the CDN 130 is performing under a threshold (e.g., 95%) or if a CDN 130 has a higher TTFB than a CDN 130 that is top-performing.

The DNS platform 126 may perform a lookup based on the DNS query and instantly cost-out or cost-in a CDN provider 102 based on the information in the steering tables 120. That is, when a user queries a target domain (via the DNS query), then a delegated canonical name (CNAME) record may return a CDN 130 to the user. The user may connect to the CDN provider 102 (e.g., the CDN provider 102-a) via a request, as described herein. In the example of the web service 128, the CDN 130-b may be automatically costed-out (represented by an “off” toggle switch) while the CDN 130-a, the CDN 130-c, and the CDN 130-d may be automatically costed in (represented by “on” toggle switches) according to the steering tables 120 indicating that traffic is to be allocated in such a way for the web service 128. A corresponding DNS result may be sent back to the user of the online marketplace 136, which may include which CDN(s) 130 are being used for the user's interactions with the web service 128. In this way, users of the online marketplace 136 may be enabled to use a CDN 130 with optimal availability and performance based on the steering logic 138 described herein.

In some implementations, when a CDN 130 has been costed-in, the data sources may continue to monitor the health of the CDN 130. For example, the data sources may continue monitoring the health of the CDN 130 to ensure the availability and performance of the CDN 130 remain above a threshold. Additionally, when a CDN 130 has been costed out, external monitors, such as the monitoring platform 104 and the mobile native platform 106 may continue monitoring the health of the CDN 130 to determine when the CDN 130 may be costed back in. As the monitoring platform 104 and the mobile native platform 106 may use synthetic monitoring, the platforms may continuously monitor the availability of the CDN 130 even while the CDN 130 is costed-out using synthetic data. When the synthetic data indicates that the CDN 130 is back to a stable availability and performance, then the CDN may be costed-back-in.

The CDN auto-steering described herein may automatically remove or limit problematic CDNs to reduce the impact of CDN outages and errors without requiring a manual change of a DNS. The auto-steering may be fully automated to utilize multiple data sources such that the steering logic 138 may make costing-out or costing-back-in decisions with high accuracy. The auto-steering may also improve the speed of costing-out actions (e.g., compared to manual actioning and self-decision-based actioning).

Having considered an example of an environment, consider now a discussion of some example details of the techniques for using an automated system for allocating traffic for CDNs based on performance and availability data in accordance with one or more implementations.

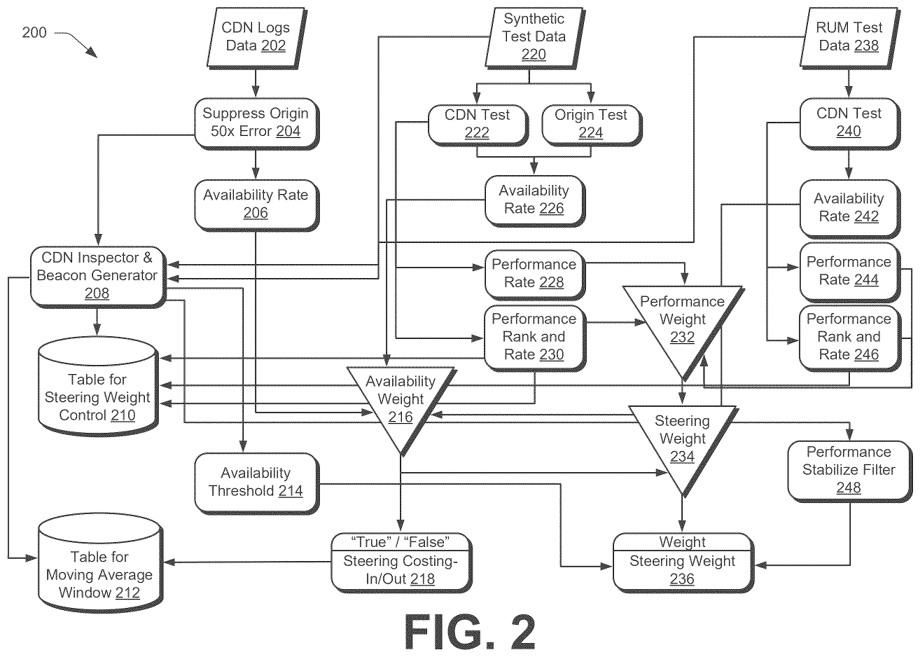

FIG. 2 depicts an example of a steering logic 200 for allocating traffic for CDNs based on performance and availability data in accordance with aspects of the present disclosure. The steering logic 200 may be implemented in or otherwise supported by the data processing platform 112, as described with reference to FIG. 1. For example, the steering logic 200 may be an example of the steering logic 138 of FIG. 1, where the data processing platform 112 may employ the steering logic 200 to automatically cost-out or cost-in CDNs based on global availability, regional availability, and regional data corresponding to each CDN.

As described herein, the steering logic 200 may collect data (which includes performance, availability, and other health information) from various data sources. For example, the steering logic 200 may collect at least one of CDN logs data 202 from CDN providers, synthetic test data 220 from a synthetic monitoring platform, or RUM test data 238 from a mobile native platform or a synthetic monitoring platform, among other data sources.

If the steering logic 200 receives the CDN logs data 202, the steering logic 200 may suppress origin 50× errors 204 from the data so as to not influence the auto-steering based on errors at an origin server. In some implementations, a CDN inspector and beacon generator 208 may use a logic to review historical availability and data over a relatively long period of time (e.g., 3 months, 6 months, 1 year) and determine a value for steering weight control after processing the historical data. The CDN inspector and beacon generator 208 may update a table for steering weight control 210 (e.g., steering tables 120 as described with reference to FIG. 1) to include the historical data. For example, the table for steering weight control 210 may store global availability, regional availability, and global data for the previous two years. A schedule query may run to update such data every week. The steering logic may evaluate the data and set a weight control value based on the data for multiple modes. For example, the steering logic may rank high-performing CDNs that have performance gaps over other CDNs and update CDN rankings if one CDN achieves a higher performance than another, keep steady CDNs that fully meet the availability condition, for example based on no CDN having a large performance gap over the other CDNs and update the default weight control value, or eliminate the worst-performing CDNs that have a large performance gap to other CDNs and update the weight value for the worst-performing CDN to zero.

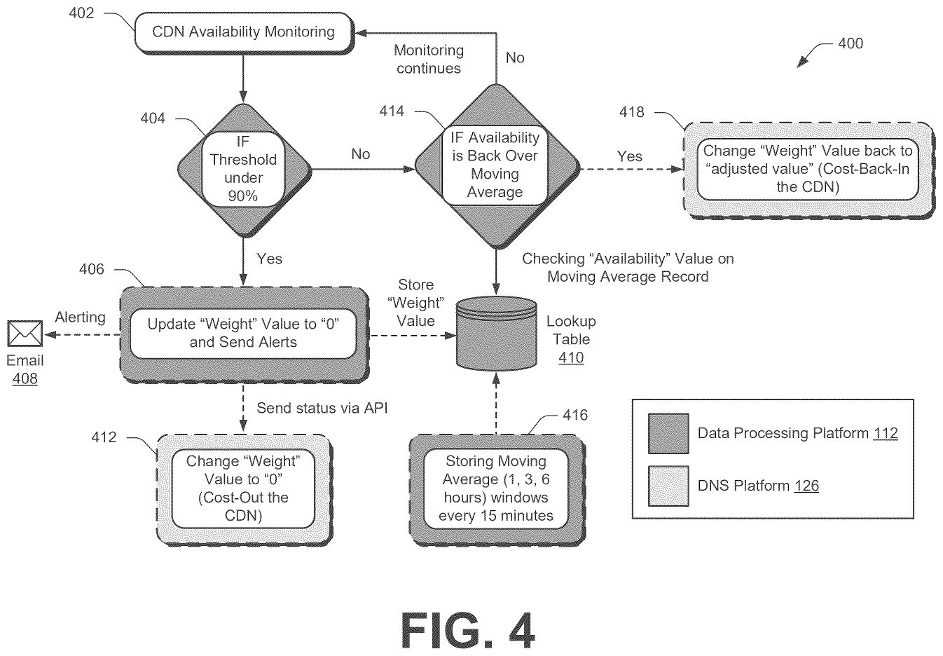

In some examples, the CDN inspector and beacon generator 208 may compare the availability of the CDN to an availability threshold 214 (e.g., 95%). Based on whether the availability of the CDN is under, equal to, or above the availability threshold 214, the steering logic 200 may determine a steering weight 236 for the CDN, which may indicate a percentage of traffic that may be directed to the CDN. Additionally, or alternatively, the CDN inspector and beacon generator 208 may update a table for a moving average window 212 based on the CDN logs data 202 (excluding the origin 50× errors 204), as described with reference to FIGS. 3 and 4.

In some implementations, from the CDN logs data 202 (excluding the origin 50× errors 204), the steering logic 200 may determine an availability rate 206. The availability rate 206 may indicate the availability (e.g., global or regional) of a CDN as a percentage. Based on the availability rate 206, the steering logic 200 may determine an availability weight 216 for the CDN, where the availability weight 216 may assist the steering logic 200 in determining how much traffic to allocate to the CDN or whether to cost-out the CDN. The availability weight 216 may trigger steering costing-in/out 218. The steering costing-in/out 218 may be based on a binary “true” “false” value, where “true” may indicate an availability at or above the availability threshold and “false” may indicate an availability below the availability threshold.

If the steering logic 200 receives the synthetic test data 220, the steering logic 200 may perform a CDN test 222 and an origin test 224. The CDN test 222 and the origin test 224 may be synthetic tests performed to continuously monitor a CDN (in some cases, when the CDN is costed-out). In some implementations, if the origin test 224 indicates that the origin server has an availability below a threshold (e.g., 98%), then the steering logic 200 may refrain from taking any auto-steering actions.

In some implementations, from the CDN test 222 and the origin test 224, the steering logic 200 may determine an availability rate 226. The availability rate 226 may indicate the availability (e.g., regional) of a CDN as a percentage. Based on the availability rate 226, the steering logic 200 may determine an availability weight 216 for the CDN, where the availability weight 216 may assist the steering logic 200 in determining how much traffic to allocate to the CDN or whether to cost-out the CDN. The availability weight 216 may trigger steering costing-in/out 218 as described herein.

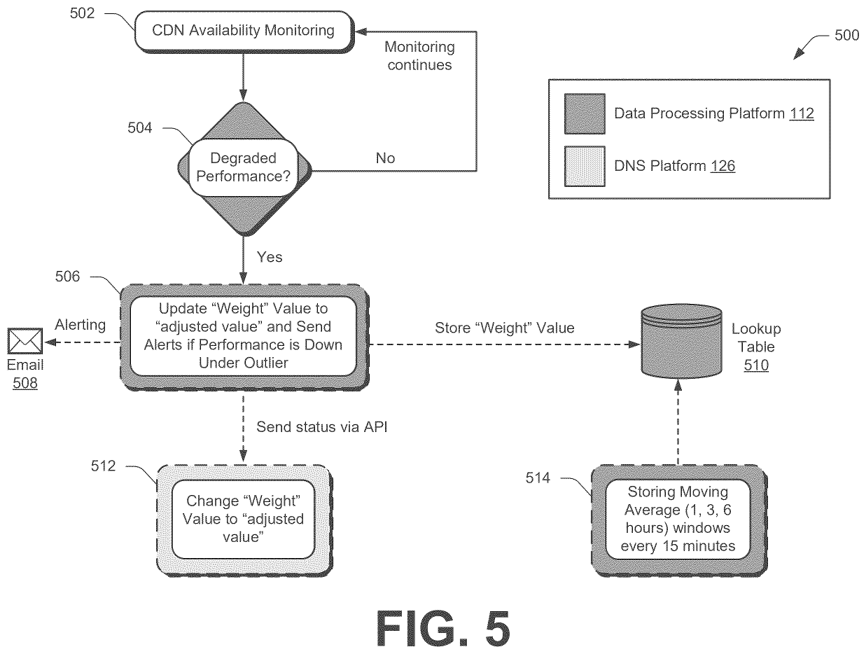

In some implementations, the results of the CDN test 222 may be used to determine a performance rate 228 (as a percentage of performance). As described herein with reference to FIG. 5, the performance rate 228 may be based on performance metrics, such as TTFB and TTFB(S), which may be included in or calculated from the synthetic test data 220. Additionally, or alternatively, the results of the CDN test 222 may be used to determine a performance rank and rate 230 (as a percentage of performance). The performance rank and rate 230 for a CDN may include a performance rank, which may indicate how a CDN ranks among other CDNs in terms of performance (e.g., a higher rank value indicates a higher performance), and a performance rate, which may be based on performance metrics, such as TTFB and TTFB(S). In some implementations, the steering logic 200 may add the performance rank and rate 230 to the table for steering weight control 210.

In some examples, the steering logic 200 may use at least one of the performance rate 228 or the performance rank and rate 230 to determine a performance weight 232, where the performance weight 232 may assist the steering logic 200 in determining a steering weight 234 of the CDN. The steering weight 234 may be combined with other steering weights determined based on data from other data sources to determine the steering weight 236 for the CDN (as a percentage of traffic).

If the steering logic 200 receives the RUM test data 238, the steering logic 200 may perform a CDN test 240, which may be synthetic tests performed to continuously monitor a CDN. The results from the CDN test 240 may be used to determine at least one of a performance rate 244 or a performance rank and rate 246. The performance rate 244 may be based on performance metrics, such as TTFB and TTFB(S), which may be included in or calculated from the RUM test data 238, and the performance rank and rate 246 for a CDN may include a performance rank, which may indicate how a CDN ranks among other CDNs in terms of performance (e.g., a higher rank value indicates a higher performance), and a performance rate, which may be based on performance metrics, such as TTFB and TTFB(S). In some implementations, the steering logic 200 may add the performance rate 244 (as a percentage) and the performance rank and rate 246 (as a percentage) to the table for steering weight control 210.

In some implementations, from the CDN test 240, the steering logic 200 may determine an availability rate 242. The availability rate 242 may indicate the availability (e.g., regional) of a CDN as a percentage. Based on the availability rate 242, the steering logic 200 may determine the steering weight 234 for the CDN, where the steering weight 234 may assist the steering logic 200 in determining how much traffic to allocate to the CDN or whether to cost-out the CDN. The steering weight 234 may contribute to the steering weight 236 as described herein.

In some implementations, the steering logic 200 may use a performance stabilize filter 248 to determine whether to cost-out a CDN or limit traffic to the CDN based on the CDN's availability and performance. For example, based on the CDN logs data 202, the synthetic test data 220, and data from other data sources, the CDN inspector and beacon generator 208 may use the performance stabilize filter 248 to determine whether to cost-out a CDN if the CDN is performing under a threshold (e.g., 95%) or if a CDN has a higher TTFB than a top-performing CDN.

The CDN inspector and beacon generator 208 may collect the data as described herein as well as additional data from other data sources. For example, the CDN inspector and beacon generator 208 may receive data that includes more user samples per country and ASN levels. The beacon generator may calculate an availability of a CDN for each country and ASN and may executed in real-time, in some cases nearly every one minute, to update availability and performance values per country and ASN. The CDN inspector and beacon generator 208 may use the availability threshold 214 to check if the availability of CDN meets an availability condition or not (based on the availability calculated by the beacon generator). In such cases, the steering logic may initiate auto-steering actions for the target of the beacon, for example, meaning that the auto-steering may be based solely on country and ASN.

Additionally, or alternatively, the beacon generator may calculate a performance value for a metric set up for performance-based auto-steering. The metric may include a numeric value of TTFB, and each beacon may have the TTFB value for a given countries and ASNs. The steering logic 200 may use the performance stabilize filter 248 to obtain a value of the “best” CDN (e.g., top-performing CDN). For example, if a threshold performance difference in CDNs (e.g., a CDN at issue and the top-performing) is 30%, and the top-performing CDN has a 100 ms TTFB while another CDN has a 140 ms TTFB, then the steering logic may automatically remove or cost-out the other CDN from the rotation of CDNs for those given countries and ASNs.

FIG. 3 depicts an example of a flow diagram 300 for allocating traffic for CDNs based on performance and availability data in accordance with aspects of the present disclosure. In the flow diagram 300, a target CDN may be costed-out or costed-in (e.g., traffic may be balanced between CDNs) based on a global availability of each CDN. In addition, the flow diagram 300 may be implemented in or otherwise supported by the data processing platform 112 and the DNS platform 126, as described with reference to FIG. 1. The processes in the flow diagram 300 may be performed in the same or a different order than as shown.

At 302, a system including the data processing platform 112 and the DNS platform 126 may perform CDN availability monitoring of one or more CDNs. In some implementations, the CDNs may support web services for an online marketplace. When monitoring for global availability of the CDNs, the data processing platform 112 may collect data for each CDN from various data sources including CDN providers, synthetic monitoring platforms, mobile native platforms, among other data sources. For example, the data may include at least one of data logs from CDN providers, synthetic monitoring data from a monitoring platform, RUM from a monitoring platform, or RUM from a mobile native platform.

To determine a global availability of a CDN based on the collected data, a steering logic enabled by the data processing platform 112 may calculate Availability=((Total Request−Error Request)/Total Request)*100, where Total Request may represent a total number of requests received by the CDN from users and Error Request may represent all 50× errors excluding 50× errors from origin response. To suppress origin errors or failures, the steering logic may exclude 50× errors of origin response considering origin outages or errors from the origin on CDN logs.

In some implementations, to balance traffic between CDNs based on global availability, the steering logic may use a binary “True” “False” status, which may indicate whether a CDN has global availability (i.e., “True) or not (i.e., “False”). The status may be based on an up/down model, where a status of “Up” may correspond to a true result (e.g., “1”) where both the CDN has global availability (e.g., “1) and the origin has global availability (e.g., “1”), or a true result (e.g., “1”) where the CDN has global availability (e.g., “1) and but the origin lacks global availability (e.g., “0”). If the origin is down (i.e., unavailable), then the overall result may be zero for all CDNs such that the CDNs maintain a same rotation of traffic and refrain from sending any data to the DNS platform 126 for auto-steering. A status of “Down” (DN) may correspond to a false result (e.g., “0”), where the CDN may lack global availability (e.g., “0”) and the origin may lack global availability (e.g., “0”). A “Down” status may indicate that the CDN is to be costed-out.

At 304, the steering logic of the data processing platform 112 may determine whether a global availability for a CDN is under a global availability threshold, such as 95%. If the steering logic is concerned with origin availability, then the availability threshold may be 98%.

At 306, if the global availability of the CDN is under 95%, then the steering logic may update an “Up” status to “false,” which may trigger the costing-out of the CDN. In some implementations, at 306, the data processing platform 112 send alerts of the costing-out and subsequent redirecting of traffic to system administrators or other users, which may include sending notifications, messages, or other alerts via email 308, a messaging application, or an incident management platform. The data processing platform 112 may store the “false” status in a lookup table 310, which may correspond to the global availability table 122 described with reference to FIG. 1.

The data processing platform 112 may send the updated “Up” status to the DNS platform 126 via an API. For example, the data processing platform 112 may send the global availability data to the DNS platform 126 in a JavaScript Object Notation (JSON) format via a data feed API. At 312, the DNS platform 126 may change the “Up” status to “false” and in doing so, cost-out the CDN. That is, the DNS platform 126 may redirect traffic away from the costed-out CDN to one or more other CDNs with global availabilities that satisfy the 95% threshold.

Alternatively, at 314, if the global availability of the CDN is equal to or greater than 95%, then the steering logic may determine whether the global availability of the CDN is back over a moving average of 1, 3, or 6 hours. That is, once a CDN has been costed-out due to a CDN issue, the steering logic may check a moving average record (stored by “Save to Look Up”) and use values in the moving average record to autonomously cost-back-in the CDN. The moving average record may include a percent moving average for the last 1 hour, the last 3 hours, and the last 6 hours, or other time frames.

At 316, the data processing platform 112 may store global availability data for moving average windows (e.g., 1 hour, 3 hours, and 6 hours) every fifteen minutes or according to another time period. Such data may include an average global availability for that CDN for the last 1, 3, or 6 hours. In some examples, the data corresponding to the moving average windows may be stored in the lookup table 310. To determine whether the availability is back over the moving average, the steering logic may check an “availability” value on the moving average record in the lookup table 310. The steering logic may pull the availability data from the lookup table 310 and utilize corresponding values to determine whether to cost-back-in the CDN.

If the availability is not back over the moving average, then the system may continue performing CDN availability monitoring. The steering logic may continue collecting data and calculating the described global availability metrics until the availability of the CDN is below the threshold. Alternatively, if the availability is over the moving average (for the last 1, 3, or 6 hours), then the steering logic may determine a percent at which to put the CDN back into rotation (of the CDNs serving user request), and the data processing platform 112 may send an indication to the DNS platform 126 to cost-back-in the CDN.

At 318, the DNS platform 126 may change the “Up” status to “True” and cost-back in the CDN at the determined percentage. In some examples, the DNS platform 126 may be triggered to cost-back-in the CDN if all of the 1 hour, 3 hour, and 6 hour moving averages are back over the 95% threshold availability. That is, the steering logic may not signal the DNS platform 126 to cost-back-in the CDN immediately after the original CDN availability data (e.g., collected from a synthetic monitoring platform) is back to a normal (e.g., a 95% or higher availability). Using moving average windows in this way may allow the steering logic enough time to determine that the CDN is stable and may be reliably costed-back in, particularly after larger drops in availability (e.g., the lower the availability, the longer it may take for the steering logic to cost-back-in the CDN).

If the CDN has been costed-out once before, then the data processing platform 112 may lack data logs corresponding to the availability of that CDN, which would be used to cost-back in the CDN. In such cases, the steering logic may utilize a synthetic monitoring platform (e.g., a synthetic data source) to collect synthetic availability data that may allow the CDN to be costed-back-in once an outage has been resolved. If no data source (real-time or synthetic) is able to provide data to the data processing platform 112, then the CDN may be removed from the global availability metric and no longer be utilized.

In some implementations, if global availability is the only metric being considered in determining whether to cost-out or cost-in a CDN, then traffic may be balanced evenly among the CDNs if all CDNs are down (e.g., have availabilities below the 95% threshold). If one of the CDNs has a weight of 0%, such that no traffic is being allocated to that CDN, and another CDN is down (e.g., has an availability below the 95% threshold), then the CDN with a weight of 0% may receive all of the traffic. In some implementations, if the origin has failures causing the origin availability to fall below the 98% threshold (e.g., based on a synthetic test), then the data processing platform 112 and the DNS platform 126 may refrain from performing any auto-steering actions.

In at least one example of auto-steering based on global availability, an outage situation may occur in which the availability of a CDN may be down globally due to an outage at the CDN. In some other examples, all CDNs may be down due to the origin server being down. In such cases, all CDNs may return 50× errors due to the outage at the origin server. In some other examples, a CDN may have an issue and be unstable, causing the availability of the CDN (e.g., the up/down status) to be right around the threshold availability. The steering logic may cost out the CDN and continue monitoring the CDN's availability with respect to the availability threshold. In some other examples, an ISP issue or some other unknown issue may cause the availability of two or three CDNs to drop below the availability threshold. The steering logic may expect that the last CDN lacks sufficient capacity to serve all of the traffic from the other two or three CDNs immediately, so the steering logic may apply static weight values for the CDNs and distribute the traffic among them. In some other examples, all CDNs may go down or experience an outage one by one. In such cases, the steering logic may maintain the last recorded weight value and use that weight to balance the traffic between the CDNs.

FIG. 4 depicts an example of a flow diagram 400 for allocating traffic for CDNs based on performance and availability data in accordance with aspects of the present disclosure. In the flow diagram 400, a target CDN may be costed-out or costed-in (e.g., traffic may be balanced between CDNs) based on a regional availability of each CDN. In addition, the flow diagram 400 may be implemented in or otherwise supported by the data processing platform 112 and the DNS platform 126, as described with reference to FIG. 1. The processes in the flow diagram 400 may be performed in the same or a different order than as shown.

At 402, a system including the data processing platform 112 and the DNS platform 126 may perform CDN availability monitoring of one or more CDNs. In some implementations, the CDNs may support web services for an online marketplace. When monitoring for regional availability of the CDNs, the data processing platform 112 may collect data for each CDN from various data sources including CDN providers, synthetic monitoring platforms, mobile native platforms, among other data sources. For example, the data may include at least one of data logs from CDN providers, synthetic monitoring data from a monitoring platform, RUM from a monitoring platform, or RUM from a mobile native platform. The steering logic may add or remove any of the data sources at any time, which may improve flexibility of the steering logic and enable the steering logic to calculate more regional availability and regional performance more accurately based on which data sources and corresponding data are available.

To determine a regional availability of a CDN based on the collected data, the steering logic may calculate ((Total Request−Error Request)/Total Request)*100 by region, where Total Request may represent a total number of requests received by the CDN from users and Error Request may represent all 50× errors excluding 50× errors from origin response. In some implementations, the system may support four geographical regions, including North America, Europe, Oceania (e.g., AU), and the rest of the world (ROW).

In some implementations, to balance traffic between CDNs based on regional availability (and regional performance, described herein with reference to FIG. 5), a steering logic enabled by the data processing platform 112 may use weight control by availability, which may indicate how much traffic a given CDN is to process. The weight control may be based on an up/down model, where a status of “Up” may correspond to a weight of 1% or greater and a regional availability at or above a threshold percentage (e.g., 90%), and where a status of “Down” (DN) may correspond to a weight of 0% and a regional availability of 0 (e.g., because the availability is under 90%). That is, the weight value for CDNs with a regional availability below the threshold percentage may be zero.

In some implementations, if the data processing platform 112 is unable to collect data from synthetic monitoring, then the steering logic may use a weight-only model instead of an up/down model. Because synthetic monitoring for continuous availability checks are unavailable, there may not be a weight of zero, meaning there may not be a fully cost-out condition when using the weight-only model. For example, a regional availability at or above a threshold percentage (e.g., 90%) may correspond to a weight of 5% or more and a regional performance between 1% and 100%, and a regional availability below the threshold percentage may correspond to a weight of 5% and a regional performance between 1% and 100%, such that the weight may be a minimum of 5% even if the availability is under the threshold percentage.

As described herein with reference to FIG. 5, in some implementations, the weight control may be based on regional availability and regional performance according to an up/down model. For example, a status of “Up” may correspond to a regional availability at or above a threshold percentage (e.g., 90%), a regional performance between 1% and 100%, and a weight of 1% or greater. A status of “Down” (DN) may correspond to a regional availability of 0 because the availability is under the threshold percentage, and a weight of 0%. For example, if the regional availability is below 90%, then the weight value may be zero. Using any of these forms of weight control, a weight of zero may indicate that that CDN is to be costed-out.

At 404, using a steering logic, the data processing platform 112 determine whether a regional availability of a CDN is below a threshold percentage, for example, 90%, using any of the above metrics. In some examples, the steering logic may utilize different regional availability metrics based on which data sources are available to provide availability and data to the steering logic.

At 406, if the regional availability is under 90%, then the steering logic may update a “Weight” status to “0 ,” which may trigger costing-out of the CDN. In some examples, at 406, the data processing platform 112 may send alerts of the costing-out and subsequent redirecting of traffic to system administrators or other users, which may include sending notifications, messages, or other alerts via email 408, a messaging application, or an incident management platform. The data processing platform 112 may store the “Weight” value in a lookup table 410, which may correspond to the regional availability and performance table 124 described with reference to FIG. 1.

The data processing platform 112 may send the updated “Weight” status to the DNS platform 126 via an API. For example, the data processing platform 112 may send the global availability data to the DNS platform 126 in a JSON format via a data feed API. At 412, the DNS platform 126 may change the “Weight” status to “0 ” and in doing so, cost-out the CDN. That is, the DNS platform 126 may redirect traffic away from the costed-out CDN to one or more other CDNs with regional availabilities that satisfy the 90% threshold (and some cases, a regional performance threshold).

Alternatively, at 414, if the regional availability of the CDN is equal to or greater than 90%, then the steering logic may determine whether the regional availability of the CDN is back over a moving average of 1, 3, or 6 hours. That is, once a CDN has been costed-out due to a CDN issue, the steering logic may check a moving average record (stored by “Save to Look Up”) and use values in the moving average record to autonomously cost-back-in the CDN. The moving average record may include a percent moving average for the last 1 hour, the last 3 hours, and the last 6 hours, or other time frames.

A moving average may be calculated by dividing a value of a recent availability by a number of time periods in the calculation average. Short-term averages may respond to changes more quickly than long-term averages. The steering logic 200 may use the moving average mechanism to cost-back-in CDNs based on the impact of availability on the long-term averages (e.g., over 1 hour, 3 hour, or 6 hour windows), which may slowly react and approach normal availabilities. For example, a large decrease in availability under a 95% threshold (e.g., a 60% availability) may affect other moving average windows and reduce the speed at which a CDN may be costed-back-in. A small decrease in availability under the 95% threshold (e.g., a 94% availability) may affect the moving average windows less, and the steering logic may cost-back-in the CDN sooner than in the previous example.

At 416, the data processing platform 112 may store regional availability data for moving average windows (e.g., 1 hour, 3 hours, and 6 hours) every fifteen minutes or according to another time period. Such data may include an average regional availability for that CDN for the last 1, 3, or 6 hours. In some examples, the data corresponding to the moving average windows may be stored in the lookup table 410. To determine whether the availability is back over the moving average, the steering logic may check an “availability” value on the moving average record in the lookup table 410. The steering logic may pull the availability data from the lookup table 410 and utilize corresponding values to determine whether to cost-back-in the CDN.

If the regional availability is not back over the moving average, then the system may continue performing CDN availability monitoring. The steering logic may continue collecting data and calculating the described regional availability metrics until the availability of the CDN is below the threshold. Alternatively, if the regional availability is over the moving average (for the last 1, 3, or 6 hours), then the steering logic may determine a percent at which to put the CDN back into rotation (of the CDNs serving user request), and the data processing platform 112 may send an indication to the DNS platform 126 to cost-back-in the CDN.

At 418, the DNS platform 126 may change the “Weight” status back to an “adjusted value” and cost-back in the CDN at the determined percentage. In some examples, the DNS platform 126 may be triggered to cost-back-in the CDN if all of the 1 hour, 3 hour, and 6 hour moving averages are back over the 90% threshold regional availability. That is, the steering logic may not signal the DNS platform 126 to cost-back-in the CDN immediately after the original CDN availability data (e.g., collected from a synthetic monitoring platform) is back to a normal (e.g., a 90% or higher regional availability). Using moving average windows in this way may allow the steering logic enough time to determine that the CDN is stable and may be reliably costed-back in, particularly after larger drops in availability (e.g., the lower the availability, the longer it may take for the steering logic to cost-back-in the CDN).

If the CDN has been costed-out once before, then the data processing platform 112 may lack data logs corresponding to the availability of that CDN, which would be used to cost-back in the CDN. In such cases, the steering logic may utilize a synthetic monitoring platform (e.g., a synthetic data source) to collect synthetic availability data that may allow the CDN to be costed-back-in once an outage has been resolved. If no data source (real-time or synthetic) is able to provide data to the data processing platform 112, then the CDN may be removed from the regional availability metric and no longer be utilized.

FIG. 5 depicts an example of a flow diagram 500 for allocating traffic for CDNs based on performance and availability data in accordance with aspects of the present disclosure. In the flow diagram 500, a target CDN may be costed-out or costed-in (e.g., traffic may be balanced between CDNs) based on a regional availability and performance of each CDN. In addition, the flow diagram 500 may be implemented in or otherwise supported by the data processing platform 112 and the DNS platform 126, as described with reference to FIG. 1. The processes in the flow diagram 500 may be performed in the same or a different order than as shown.

At 502, a system including the data processing platform 112 and the DNS platform 126 may perform CDN performance monitoring of one or more CDNs. In some implementations, the CDNs may support web services for an online marketplace. When monitoring regional availability and performance of the CDNs, the data processing platform 112 may collect data for each CDN from various data sources including CDN providers, synthetic monitoring platforms, mobile native platforms, among other data sources. For example, the data may include at least one of data logs from CDN providers, synthetic monitoring data from a monitoring platform, RUM from a monitoring platform, or RUM from a mobile native platform. The steering logic may add or remove any of the data sources at any time, which may improve flexibility of the steering logic and enable the steering logic to determine regional availability and regional performance more accurately based on which data sources and corresponding data are available.

To determine a regional availability of a CDN based on the collected data, the steering logic may calculate ((Total Request−Error Request)/Total Request)*100 by region, where Total Request may represent a total number of requests received by the CDN from users and Error Request may represent all 50× errors excluding 50× errors from origin response. To determine a regional performance of the CDN based on the collected data, the steering logic may calculate various metrics from various sources, including performance metrics, availability metrics, speed and efficiency metrics, and so forth. By way of example, the steering logic may calculate an average TTFB(S) by country or by region. By way of another example, the steering logic may calculate metrics such as FCP, LCP, and any other new metrics that may be captured and exported via numerous sources. In some implementations, the system may support four geographical regions, including North America, Europe, Oceania (e.g., AU), and the rest of the world (ROW).

The steering logic may rely on data from synthetic monitoring and/or RUM to determine performance metrics such as TTFB and TTFB(S). Because such performance metrics from multiple data sources may have different numeric values (e.g., due to differences in how measurements are taken by the different data sources), the TTFB value may be converted to a rate such that the values may be compared for different CDNs. Accordingly, the steering logic may calculate a total TTFB(S), which may be a sum of all of the average TTFB(S) values from the different synthetic monitoring and RUM data sources, and a rate by average TTFB(S), which may be calculated as (TotalTTFB(S)−avgTTFB(S))/TotalTTFB(S)*100, where TotalTTFB(S) may represent the total TTFB(S) from all of the data sources and avgTTFB(S) may represent an average TTFB(S) value from a given data source. In addition, the steering logic may calculate a regional performance rate for weight as (Performance Rate/Total Performance Rate)*100, where Performance Rate may represent how well a given CDN is performing regionally as a percentage and Total Performance Rate may represent a highest possible performance rate as a percentage.

As described herein with reference to FIG. 4, in some implementations, the steering logic may utilize weight control based on regional availability and regional performance according to an up/down model. For example, a status of “Up” may correspond to a regional availability at or above a threshold percentage (e.g., 90%), a regional performance between 1% and 100%, and a weight of 1% or greater. A status of “Down” (DN) may correspond to a regional availability of 0 because the availability is under the threshold percentage, and a weight of 0%. For example, if the regional availability is below 90%, then the weight value may be zero. Using any of these forms of weight control, a weight of zero may indicate that that CDN is to be costed-out.

In some implementations, the steering logic may calculate a performance rank based on the data collected from the synthetic monitoring and RUM. That is, the steering logic may rank target CDN providers by their performance in order to adjust tunable values. A rank based on average TTFB(S) may be referred to as a reverse rank, and may be calculated as (CDN count+1)−(current rank based on avgTTFB(S)), where CDN count may represent a number of target CDNs and current rank based on avgTTFB(S) may represent a numeric rank of the CDNs based on an avgTTFB(S) value for that CDN (e.g., 3, 2, 1). If a total TTFB(S) value for a CDN is zero, then the performance rank for that CDN may be zero (i.e., no TTFB(S) indicates that there are no performance metrics for that CDN due to a monitoring failure). A lower performance rank corresponds to lower-performing CDNs (e.g., the worst performing CDNs correspond to a rank of 1 or 0).

In some implementations, the steering logic may perform steering weight control based on rank and using the lookup table 510. Steering weight control may enable the steering logic to adjust weight per rank, which may include assigning a higher rank value for a top-performing CDN. For example, if there are three CDNS, a top-performing CDN may be assigned a rank value of 8 instead of 3 (i.e., the ranking order may be 8, 2, 1 instead of 3, 2, 1). In some examples, a static steering weight control table may include static values for ranks for specific regions.

Performance rank for weight may be calculated as (Rank/Total Rank)*100, where Rank may represent a rank of a given CDN and Total Rank may represent a highest rank (e.g., 8 in the previous example). A performance from rank to ratio (%) may be calculated as (Total Rank of a CDN/Total Rank from all CDNs)*100. For example, if there are three target CDNs, and the rank numbers are 3, 2, and 1, then Total Rank=3+2+1=6. If the Total Rank of a CDN is 3, then the performance from rank ratio for the CDN is (3/6)*100=50%.

In some implementations, the steering logic may consolidate two rate and rank values to calculate a regional performance rate of a CDN. The regional performance rate (%) may be calculated as (Performance Rate for weight+Performance Rank for weight)/2. In some implementations, the steering logic may consolidate the regional availability and performance rate metrics for auto-steering. For example, the steering logic may calculate Regional Weight (m_rank)=Regional Availability (%)×Regional Performance Rate (%), Total Regional Weight (total_m_rank)=sum of all Regional Weight, and Regional Weight (%)=(Regional Weight/Total Regional Weight)*100.

At 504, based on the performance metrics described herein, the steering logic may determine whether a CDN experienced degraded performance over some time period. As the steering logic may control regional performance auto-steering based on CDN weights, if a performance of a CDN degrades, then steering logic may lower the weight value for that CDN. That is, the steering logic may allocate less traffic to CDNs with lower performance. In some examples, the steering logic may utilize different regional performance metrics based on which data sources are available to provide availability and data to the steering logic.

At 506, if a CDN has degraded performance, then the steering logic may update a “Weight” value to an “adjusted value,” which may trigger traffic to be allocated away from that CDN or costing-out of the CDN. In some examples, at 506, the data processing platform 112 may send alerts of the costing-out and subsequent redirecting of traffic to system administrators or other users, which may include sending notifications, messages, or other alerts via email 508, a messaging application, or an incident management platform. The data processing platform 112 may store the “Weight” value in a lookup table 510, which may correspond to the regional availability and performance table 124 described with reference to FIG. 1.

The data processing platform 112 may send the updated “Weight” value to the DNS platform 126 via an API. For example, the data processing platform 112 may send the global availability data to the DNS platform 126 in a JSON format via a data feed API. At 512, the DNS platform 126 may change the “Weight” value to the “adjusted value” and cost-out the CDN. That is, the DNS platform 126 may redirect traffic away from the costed-out CDN to one or more other CDNs with regional availabilities that satisfy performance requirements of the system. In some examples, the DNS platform 126 may run a search query per region of the data sources in real-time (e.g., for a period within the last fifteen minutes), and the DNS platform 126 may update the numeric value for “Weight” based on that data. If a failure occurred while updating the “Weight” value, then the DNS platform 126 may use the last-updated value.

Alternatively, if the regional performance of the CDN has not degraded, then the steering logic may continue performing CDN availability monitoring. The steering logic may continue collecting data and calculating the described performance metrics until a performance degradation occurs.

At 514, the data processing platform 112 may store average weight values for moving average windows (e.g., 1 hour, 3 hours, and 6 hours) every fifteen minutes or according to another time period. Such data may include an average regional availability for that CDN for the last 1, 3, or 6 hours. In some examples, the data corresponding to the moving average windows may be stored in the lookup table 510. The data processing platform 112 may store the moving averages of the weight values every 15 minutes to track how the weight values change over time. In addition, the average weight values may allow users to track request counts by target country (e.g., via a dashboard of the steering logic).

In some implementations, the steering logic may consider global availability, regional availability, and regional performance in determining whether to cost-out or cost-in a CDN. In such cases, if all CDNs are down, then the steering logic may balance all of the CDNs with the latest weight value that was updated for regional steering. If all CDNs are down and the regional weight value is zero, then the steering logic may balance all of the CDNs evenly. If one CDN has a weight value of zero for any reason, and if another CDN is down, then the CDN with the weight value of zero will assume all of the traffic.

Having discussed exemplary details of an automated system for allocating traffic for CDNs based on performance and availability data, consider now some examples of procedures to illustrate additional aspects of the techniques.

This section describes examples of procedures for an automated system for allocating traffic for CDNs based on performance and availability data. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

In at least one example of auto-steering based on regional availability and regional performance, an outage situation may occur in which the regional availability of a CDN may be down regionally and performance of the CDN may be down due to an outage at the CDN. In some other examples, all CDNs may be down due to the origin server being down, which may result in a decrease in performance. In such cases, all CDNs may return 50× errors due to the outage at the origin server. In some other examples, a CDN may have an issue and be unstable, causing the availability of the CDN (e.g., the up/down status) to be right around the threshold availability and the performance to degrade. The steering logic may cost out the CDN and continue monitoring the CDN's availability with respect to the availability threshold. In some other examples, all CDNs may go down or experience an outage one by one. In such cases, the steering logic may shift traffic to other CDNs until those CDNs also go down.

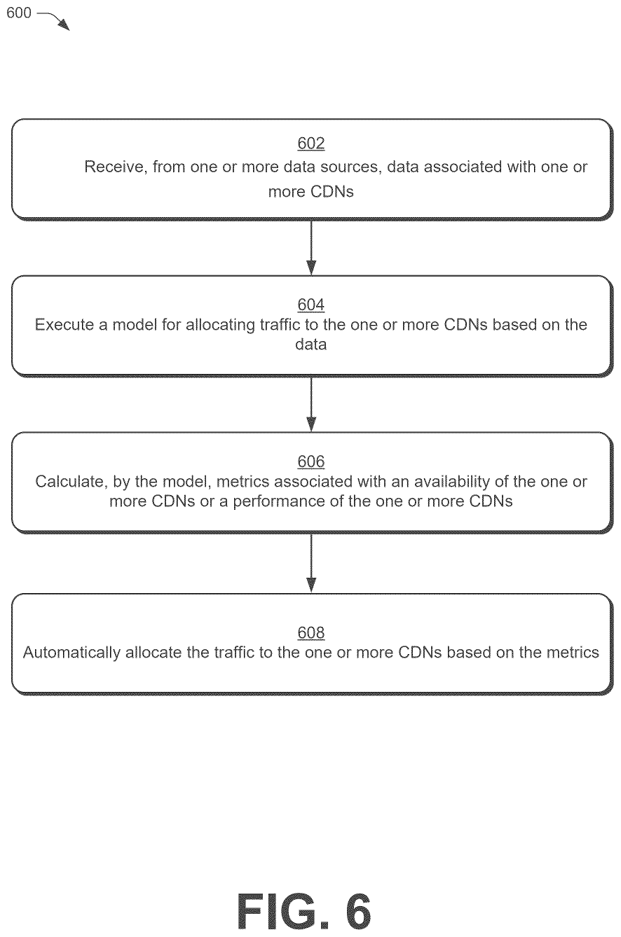

FIG. 6 depicts a procedure 600 in an example implementation of allocating traffic for CDNs based on performance and availability data.

Data associated with one or more CDNs is received from one or more data sources (block 602). By way of example, the one or more data sources may include CDN providers 102, a monitoring platform 104, and a mobile native platform 106. The CDN providers 12 may monitor the performance and availability of CDNs 130 in real-time, the monitoring platform 104 may perform synthetic monitoring of the CDNs 130, and the mobile native platform 106 may perform RUM. The data sources may provide the data to a collector of a data processing platform 112. The data processing platform 112 may support a steering logic 138 (e.g., a model).

A model for allocating traffic to the one or more CDNs based on the data may be executed (block 604). By way of example, the model may be referred to as the steering logic 138 that is supported by the data processing platform 112. The model may determine data 116 from the data, which may be used to cost-out or cost-in different CDNs 130.

Metrics associated with an availability of the one or more CDNs or a performance of the one or more CDNs may be determined by the model (block 606). By way of example, the metrics may include a global availability, a regional availability, and a regional performance for the CDNs 130. Calculating such metrics may enable the steering logic 138 to determine a percentage of the traffic to allocate to each CDN 130 (e.g., a weight).

The traffic may be automatically allocated to the one or more CDNs based on the metrics (block 608). By way of example, the steering logic 138 may use the metrics to allocate a percentage of the traffic to each CDN 130. Some CDNs 130 may be costed-out, such that they may no longer receive traffic until an availability or a performance of the CDNs 130 improves. Additionally, or alternatively, some CDNs 130 may be costed-back-in (if previously costed-out) if their availability or performance has improved. In some implementations, the data processing platform 112 may send an API call to the DNS platform 126 indicating the steering (e.g., percent traffic allocations), and the DNS platform 126 may actually facilitate the directing of traffic to and from different CDNs 130.

Having described examples of procedures in accordance with one or more implementations, consider now an example of a system and device that can be utilized to implement the various techniques described herein.

FIG. 7 illustrates an example of a system 700 generally that includes an example of a computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, from one or more data sources, data associated with one or more content delivery networks (CDNs);
executing a model for allocating traffic to the one or more CDNs based on the data;
determining, by the model, metrics associated with an availability of the one or more CDNs or a performance of the one or more CDNs; and
automatically allocating the traffic to the one or more CDNs based on the metrics.

2. The computer-implemented method of claim 1, wherein determining the metrics associated with the availability further comprises:
calculating, by the model, a global availability of each CDN of the one or more CDNs based on the data, wherein the data includes a number of requests associated with each CDN and a number of errors associated with each CDN; and
allocating the traffic to the one or more CDNs based on the global availability of the one or more CDNs satisfying a threshold.

3. The computer-implemented method of claim 1, wherein determining the metrics associated with the availability further comprises:
calculating, by the model, a regional availability of each CDN of the one or more CDNs based on the data, wherein the data includes a number of requests associated with each CDN and a number of errors associated with each CDN ; and
allocating the traffic to the one or more CDNs based on the regional availability of the one or more CDNs satisfying a threshold.

4. The computer-implemented method of claim 1, wherein determining the metrics associated with the performance further comprises:
calculating, by the model, a regional performance of each CDN of the one or more CDNs based on the data; and
allocating the traffic to the one or more CDNs based on the regional performance of the one or more CDNs.

5. The computer-implemented method of claim 1, wherein the data is received from the one or more data sources based on at least one of synthetic monitoring or real user monitoring (RUM).

6. The computer-implemented method of claim 1, wherein determining the metrics associated with the availability and the performance further comprises:
calculating, by the model, a weight corresponding to each CDN of the one or more CDNs, wherein the weight indicates a percentage of the traffic to be allocated to each CDN; and
allocating the traffic to the one or more CDNs based on the weight of the one or more CDNs.

7. The computer-implemented method of claim 1, further comprising:
detecting one or more errors at an origin server, the one or more errors associated with an availability of the origin server; and
executing the model for allocating the traffic without including the one or more errors in the data.

8. The computer-implemented method of claim 1, further comprising determining, based on the metrics, that a first CDN of the one or more CDNs experienced an outage, wherein the traffic is allocated to the one or more CDNs except for the first CDN based on the outage.

9. The computer-implemented method of claim 1, wherein automatically allocating the traffic comprises switching the traffic from a first CDN to a second CDN of the of the one or more CDNs based on a performance or an availability of the second CDN being more than a performance or an availability of the first CDN.

10. The computer-implemented method of claim 1, further comprising:
calculating, by the model, an average availability of each CDN of the one or more CDNs based on an availability of each CDN and a quantity of time periods during which the availability was measured; and
allocating the traffic to the CDNs based on the average availability of the one or more CDNs.

11. The computer-implemented method of claim 1, wherein the one or more data sources include at least one of a CDN provider, an Internet performance monitoring platform, or real user monitoring (RUM).

12. The computer-implemented method of claim 1, further comprising:
sending an indication of the allocation of the traffic to a domain name system (DNS) platform via an application programming interface (API) call.

13. The computer-implemented method of claim 1, further comprising:
generating a visual representation of the allocation of the traffic to the one or more CDNs; and
sending, for display via a user interface, the visual representation.

14. A system comprising:
one or more processors; and
memory storing instructions that, when executed by the one or more processors, cause the system to:
receive, from one or more data sources, data associated with one or more content delivery networks (CDNs);
execute a model for allocating traffic to the one or more CDNs based on the data;
determine, by the model, metrics associated with an availability of the one or more CDNs or a performance of the one or more CDNs; and
automatically allocate the traffic to the one or more CDNs based on the metrics.

15. The system of claim 14, wherein the instructions further cause the system to determine, by the model, the metrics associated with the performance of the one or more CDNs.

16. The system of claim 14, wherein the instructions further cause the system to determine, by the model, the metrics associated with the availability of the one or more CDNs.

17. The system of claim 15, wherein, to determine the metrics associated with the availability, the instructions further cause the system to:
calculate, by the model a global availability of each CDN of the one or more CDNs based on the data, wherein the data includes a number of requests associated with each CDN and a number of errors associated with each CDN; and
allocate the traffic to the one or more CDNs based on the global availability of the one or more CDNs satisfying a threshold.

18. A non-transitory computer-readable media storing instructions that, when executed by one or more processors, cause the one or more processors to perform operations including:
receiving, from one or more data sources, data associated with one or more content delivery networks (CDNs);
executing a model for allocating traffic to the one or more CDNs;
determining, by the model, metrics associated with an availability of the one or more CDNs or a performance of the one or more CDNs; and
automatically allocating the traffic to the one or more CDNs based on the metrics.

19. The non-transitory computer-readable media of claim 18, wherein the instructions cause the one or more processors to determine, by the model, the metrics associated with the performance of the one or more CDNs.

20. The non-transitory computer-readable media of claim 18, wherein the instructions cause the one or more processors to determine, by the model, the metrics associated with the availability of the one or more CDNs.
